(19) United States
(12) Patent Application Publication
(10) Pub. No.: US 2007/0009177 A1
(43) Pub. Date: Jan. 11, 2007

(54) Method for reproducing an image frame

(76) Inventor: Cheng-I Chien, Taipei City (TW)

Correspondence Address: J.C. PATENTS, INC.;SUITE 250, 4 VENTURE, IRVINE, CA, 92618, US

(21) Appl. No.: 11/338,163

(22) Filed: Jan. 23, 2006

(30) Foreign Application Priority Data
Jul. 5, 2005 (TW) 94122655

(51) Int. Cl. G06K 9/40; G06K 9/22

(52) U.S. Cl. 382/275; 382/313

(57) ABSTRACT

A method for reproducing an image frame in an electronic device to improve a shift of reference points in a distorted frame is provided. The first of the method is to generate a plurality of offsets by comparing a pre-stored matrix of reference points with a corresponding matrix of testing points transferred in the frame via a processor. Then, the processor uses those offsets and a plurality of off-axis values of the reference points to generate a distortion function, and then the processor uses the distortion function and the plurality of off-axis values of the reference points to generate a counter-distortion function. Finally, the processor calculates the matrix of reference points based on the counter-distortion function to obtain a reproduced image frame outputted by a display module. The processor can revise the shifted reference points to correct locations identified by the counter-distortion function with the calculation of the processor.

### CROSS-REFERENCE TO RELATED APPLICATION

This application claims the priority benefit of Taiwan application serial no. 94122655, filed on Jul. 5, 2005. All disclosure of the Taiwan application is incorporated herein by reference.

### BACKGROUND OF THE INVENTION

1. Field of Invention

The present invention relates to a method for reproducing an image frame, and more particularly, to a method for reproducing an image frame in a handheld electronic device with a capture module for capturing the image.

2. Description of Related Art

To meet the aggressive demand of the market, various functions such as surfing on the internet, taking pictures, etc., have been continuously added to the handheld electronic products such as the mobile telephone, the PDA (Personal Digital Assistant) and the notebook computer along with different commercial trends in the current market. Accordingly, the research and development of manufacturers nowadays has focused on how to produce a more vivid frame for the handheld device with a capture device to enable the users to record their viewing objects.

Referring to FIG. 1, which is a schematic diagram illustrating the offset of the reference point of a conventional image frame through a capture device. In FIG. 1, a capture device 10 comprises a lens 40. A reference point A in an image frame 20 is changed into a reference point A′ in an image frame 30 through the lens 40 after the capture device 10 has captured the image frame 20. The distance between the reference point A and a center point C of the image frame 20 is R, and the distance between the reference point A′ and a center point C′ of the image frame 30 is R′. Accordingly, the reference point A has been moved by a difference between the distances R and R′, to generate a distortion of the image frame 20. It is unavoidable for the reference point in an image frame to shift after the image frame has been captured by a capture device, which is shown by FIG. 1. Though different offsets would be obtained with different capture devices, such drawbacks are difficult to overcome.

Therefore, the invention provides a method for reproducing an image frame in an electronic device, in order to correct the distortion of an image frame generated by passing through a capture device of an electronic device.

### SUMMARY OF THE INVENTION

Accordingly, the major purpose of the present invention is to provide a method for reproducing an image frame in an electronic device, in order to correct the distortion of an image frame generated by passing through a capture device of an electronic device.

The further purpose of the present invention is to provide a method reproducing an image frame in an electronic device, in order to simulate an offset of a reference point in the image frame via a image frame captured by a capture device of the electronic device and a pre-stored matrix of reference points, and to simulate a more precise distortion according to a matrix of reference points with more reference points for subsequently reproducing a more precise image frame.

The further purpose of the invention is to provide a method for reproducing an image frame in an electronic device to enable the electronic device to dynamically produce various counter-distortion functions and further correct different distortions generated after the image frame passing through different capture devices, without pre-setting the counter-distorting functions in the manufacturing process of electronic device.

In order to achieve the above purposes, the present invention provides a method for reproducing an image frame in an electronic device, the electronic device comprises a capture module, a processor, a memory unit and a display module, the method comprises: storing a matrix of reference points with a plurality of reference points into the memory unit, wherein the distances between the reference points and the center point of the matrix of reference points are a plurality of off-axis values of reference points; capturing an image frame through the capture module to generate a matrix of testing points, wherein the matrix of testing points comprises a plurality of testing points; then calculating a plurality of offsets from the testing points to the reference points by the processor, utilizing the offsets and the off-axis values of reference points to generate a distortion function via the processor based on a regression method, and utilizing the distortion function and the off-axis values of reference points for the processor calculating counter-distortion function; and finally calculating the matrix of reference points via the processor according to the counter-distortion function to provide a undistorted image frame corresponding to the image frame, and output the reproduced image frame through the display module.

According to the above concepts, any one of the offsets Δ_{D} γ can be derived from the equation: Δ_{D} γ=γ−γ′, wherein γ is any one of off-axis values of the reference point, γ′ is an off-axis value of testing point, which is the distance between a testing point corresponding to the reference point and the center point of the matrix of testing points.

According to the above concepts, the regression method is a Least-Squares method. The distortion function Δ(γ) is derived by using the regression method, Δ(γ)=Δ_{D}γ=β₀β₁γ, wherein both β₀ and β₁γ are regression coefficients.

According to the above concepts,

$${β}_{1} = {\sum }_{i = 1}^{n} ( {γ}_{i} - \overline{γ} ) ( {Δ}_{D} {γ}_{i} - \overline{{Δ}_{D} γ} ) / {\sum }_{i = 1}^{n} {( {γ}_{i} - \overline{γ} )}^{2} , {β}_{0} = \overline{{Δ}_{D} γ} - {β}_{1} \overline{γ} , \\ \overline{γ} = \frac{1}{n} {\sum }_{i = 1}^{n} {γ}_{i} , \overline{{Δ}_{D} γ} = \frac{1}{n} {\sum }_{i = 1}^{n} {Δ}_{D} {γ}_{i} ,$$

wherein n is the number of the testing points.

According to the above concepts, the testing points function U⁻¹(γ) is determined by the equation: U⁻¹(γ)=γ+Δ(γ).

Compared with the conventional technology, the present invention has advantageous effects discussed as follows. The present invention provides a method for reproducing an image frame in an electronic device, which not only improves a distortion of an image frame of the conventional technology generated after the image frame being captured by a capture module of the electronic device , but also stimulates the offset of the reference point in the image frame by using a pre-stored matrix of reference points and the image frame, and further stimulates more accurate distortion according to the matrix of reference points with more reference points, thereby subsequently reproducing more precise image frames. Furthermore, the electronic device can dynamically generate various counter-distortion functions, and then correct the different distortions that are generated after the image frame passing through the different capture devices, without pre-setting the counter-distortion functions in the manufacturing process of electronic devices. Therefore, the present invention has a value for industry development.

In order to the make the aforementioned and other objects, features and advantages of the present invention more easily to understand, in accompany with figures, a number of preferred embodiments are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a schematic diagram illustrating the offset to the reference point of a conventional image frame using a capture device.

FIG. 2 is a schematic diagram illustrating the electronic device of the preferred embodiment of the invention.

FIG. 3 is a schematic diagram illustrating the comparison between the matrix of reference points in FIG. 2 vs. the matrix of testing points generated by the capture module.

FIG. 4A is a schematic diagram illustrating the offsets of the three selected reference points.

FIG. 4B is a schematic diagram illustrating the offsets of the three selected testing points.

FIG. 5 is the flow chart of the preferred embodiment of the present invention.

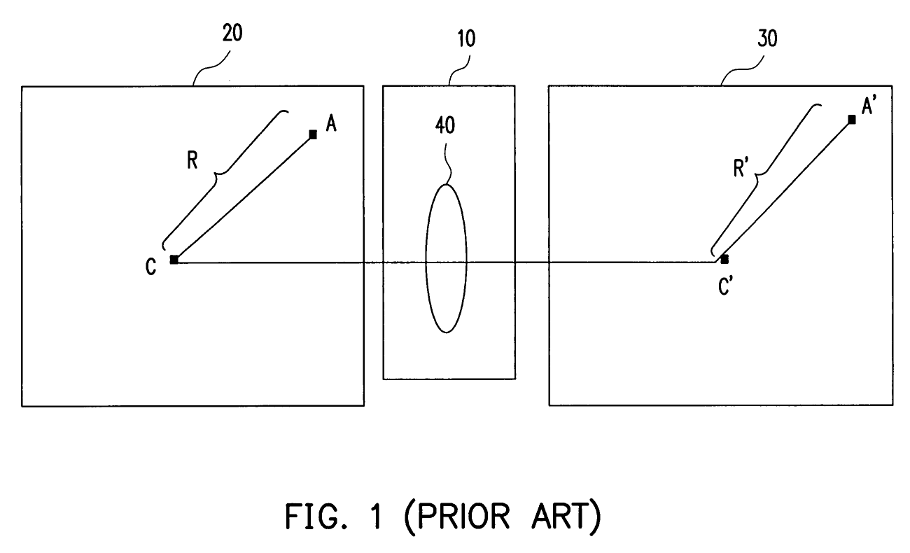

### DESCRIPTION OF EMBODIMENTS

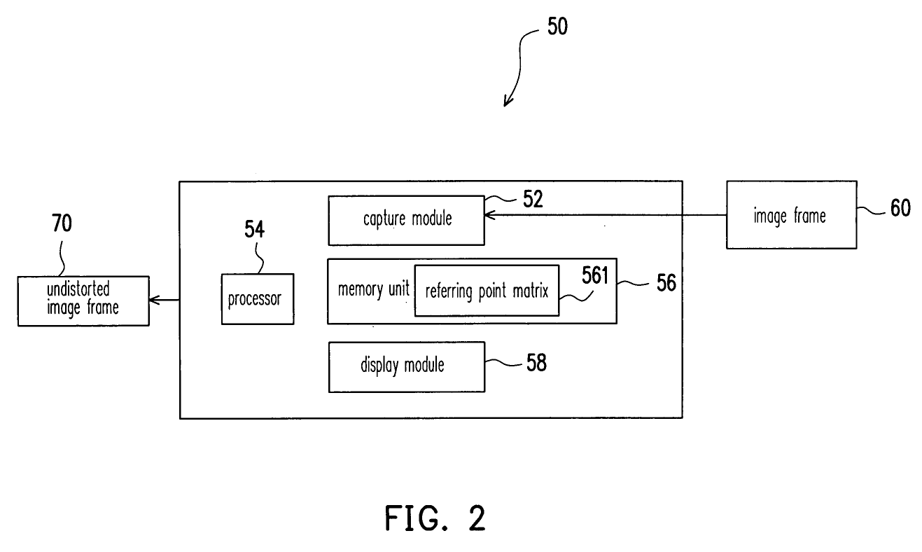

Referring to FIG. 2, a schematic diagram of the electronic device of the preferred embodiment of the invention, the electronic device 50 in the FIG. 2 comprises a capture module 52, a processor 54, a memory unit 56 and a display module 58, wherein the electronic device 50 is a handheld electronic device (such as mobile telephone, PDA, notebook computer), and the processor 54 is used to control the operation among the capture module 52, the memory unit 56 and the display module 58. Firstly, the processor 54 saves the matrix of reference points 561 into the memory unit 56 in advance by the memory unit 56, and then the capture module 52 captures the image frame 60, a digital image, and the processor 54 converts the image frame 60 into matrix format, such as the matrix of testing points 60 (not shown in FIG. 2).

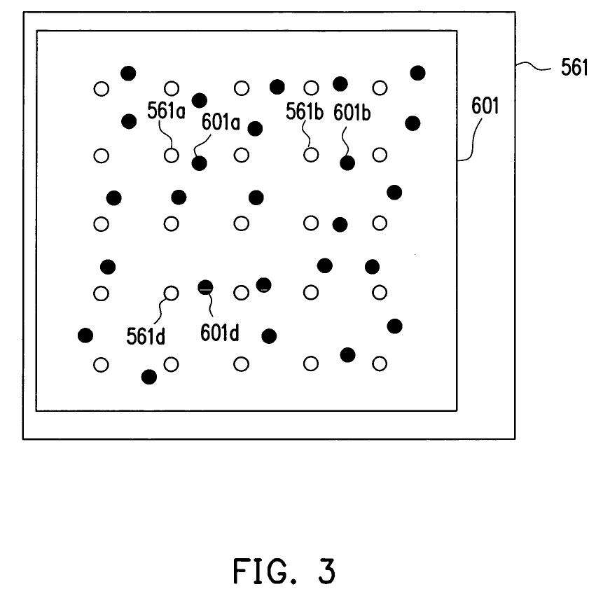

Referring to FIG. 3, the comparison between the matrixes of reference points in FIG. 2 vs. the matrix of testing points generated by the capture module is illustrated. The matrix of reference points 561 comprises the reference points 561a, 561b, 561c and other reference points 22, wherein the reference point is represented respectively with the hollow circles and these 25 reference points are arranged regularly with a fixed space among the reference points. The matrix of testing points 601 comprises the testing points 601a, 601b, 601c and other testing points 22 and the testing points are represented by the solid circles, wherein the testing points 601a, 601b, 601c correspond to the reference points 561a, 561b and 561c.

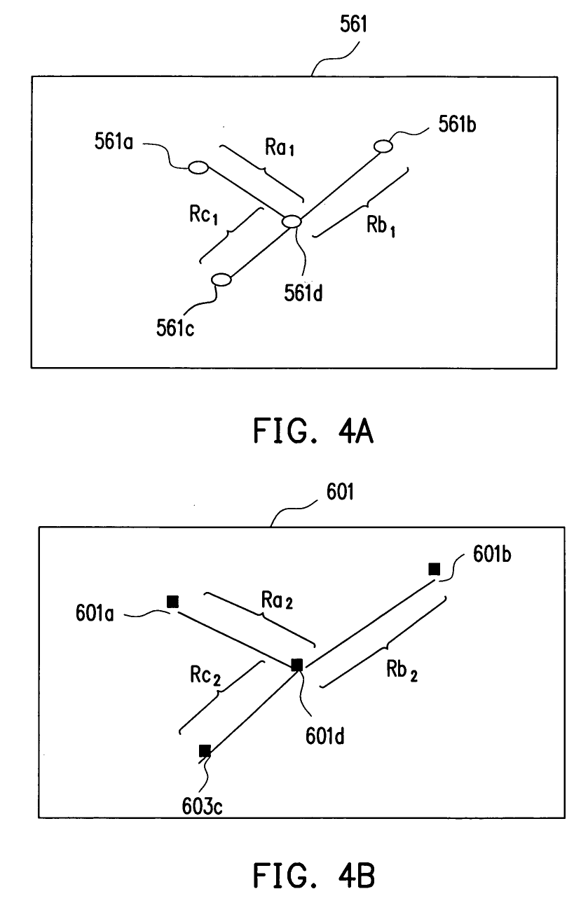

Referring to FIG. 4A and 4B, FIG. 4A is a schematic diagram of the offset to the three selected reference points and FIG. 4B is a schematic diagram of the offset to the three selected testing points. In FIG. 4A, the reference point 561d is the center point of the matrix of reference points and the distances between the reference points 561a and 561d, between the reference points 561b and 561d, between the reference points 561c and 561d are the off-axis values of the three reference points: Ra1, Rb1, Rc1, respectively. In FIG. 4B, the testing point 601d is the center point of matrix of the testing points and the distances between the testing points 601a and 601d, between the testing points 601b and 601d, between the testing points 601c and 601d are the off-axis values of three testing point: Ra2, Rb2, Rc2, respectively.

After the matrix of the testing points 601 is generated, the processor 54 begins to calculate process of the three offsets between the reference points 561a, 561b, 561c and the testing points 601a, 601b, 601c, respectively. Any one of the three offsets Δ_{D}γ can be derived through the following equation: Δ_{D}γ=γ−γ′, wherein γ is the off-axis value of any reference point (such as: Ra1, Rb1, Rc1), γ′ is the off-axis value of a testing point, which is the distance (such as: Ra2, Rb2, Rc2) between a testing point corresponding to the reference point and the center point (such as: the testing point 601d) of the matrix of the testing points 601.

In a preferred embodiment of the invention, Ra1, Rb1, Rc1 are 7, 5, 4, respectively, and Ra2, Rb2, Rc2 are 6, 3, 2, respectively; therefore, the processor 54 may identify that the offsets from the reference points 561a, 561b, 561c to the testing points 601a, 601b, 601c are 1, 2, 2 with the values after subtracting the Ra2, Rb2, Rc2 from the Ra1, Rb1, Rc1, respectively.

In the next step, the processor 54 uses the offsets 1, 2, 2 and the off-axis values of the three reference points: Ra1, Rb1, Rc1 to generate a distortion function A (γ) based on a regression method. In the preferred embodiment of the present invention, the regression method is a Least-Squares method by which the distortion function A (γ) is derived: Δ(γ)=Δ_{D}γ=β₀+β₁γ, wherein β₀ and β₁ are regression coefficients,

$${β}_{1} = {\sum }_{i = 1}^{n} ( {γ}_{i} - \overline{γ} ) ( {Δ}_{D} {γ}_{i} - \overline{{Δ}_{D} γ} ) / {\sum }_{i = 1}^{n} {( {γ}_{i} - \overline{γ} )}^{2} , {β}_{0} = \overline{{Δ}_{D} γ} - {β}_{1} \overline{γ} , \\ \overline{γ} = \frac{1}{n} {\sum }_{i = 1}^{n} {γ}_{i} , \overline{{Δ}_{D} γ} = \frac{1}{n} {\sum }_{i = 1}^{n} {Δ}_{D} {γ}_{i} ,$$

wherein n equals 3. Therefore, the results β₀=3.570 and β₁=−0.357 can be obtained and the distortion function Δ(γ) is Δ_{D}γ=3.570−0.357γ.

Accordingly the processor 54 can stimulate the offset values of the matrix of the testing points 601 and other 22 testing points by means of the distortion function Δ(γ) and stimulate more accurate distortion according to the matrix of reference points including more reference points to subsequently recover more precise image frame because the distortion function Δ(γ) is derived by the processor 54 by comparing the pre-stored reference point matrix 561with the matrix of testing points 601 transferred from the image frame 60 to identify the offsets of the testing points 601i a, 601b and 601c, etc., and to stimulate the offsets of the reference points in the image frame.

In the next step, the processor 54 utilizes the above-described distortion function Δ_{D}γ=3.570−0.357γ and γ to generate an counter-distortion function U^{-1 (. ). The counter-distortion function . . . (. ) is determined by the following equation: (. ). . . . (. ). So, . . . (. )=}3.570+0.642. is obtained.

Finally, the processor 54 calculates the reference points matrix 561 according to the counter-distortion function . . . (. ) to provide a reproduced image frame 70 without distortion corresponding to the image frame 60, and outputs the reproduced image frame 70 by the display module 58. In the preferred embodiment of the present invention, the processor 54 uses the off-axis values of the three reference points: Ra1, Rb1, Rc1 as the arguments of the counter-distortion function . . . (. ), i.e. substitutes the =(Ra1, Rb1, Rc1) into (. ) to obtain (Ra1, Rb1, Rc1)=(8.070, 6.784, 6.142). Accordingly, the distances between the testing points 601a, 601b, 601c corresponding to the reference points 561a, 561b, 561c and the center point of matrix the testing points 601 has been corrected into 8.070, 6.784 and 6.142, respectively. With the similar means, the processor 54 calculates the other 22 reference points in the matrix of reference points 561 according to the counter-distortion function . . . (. ) to generate a counter-distortion matrix, and then the processor 54 uses the counter-distortion matrix to provide the counter-distortion image frame 70 corresponding to the image frame 60, wherein the processor 54 can transfer the counter-distortion matrix into a reproduced n image frame 70 without distortion and output the reproduced image frame 70 by the display module 58 because the counter-distortion image frame is a digital image.

Given lines are defined by points and frames are defined by lines, the shape of the lines in the frame can be changed by adjusting the distance between two points. Therefore, the locations where the 25 testing points in the matrix of testing points 601 should appear are stimulated with the preferred embodiment of the present invention. In view of the foregoing description, the present invention provides a counter-distortion method for reproducing an image frame in the electronic device 50 to correct the distortion of the image frame 60 generated by passing through the capture device 52.

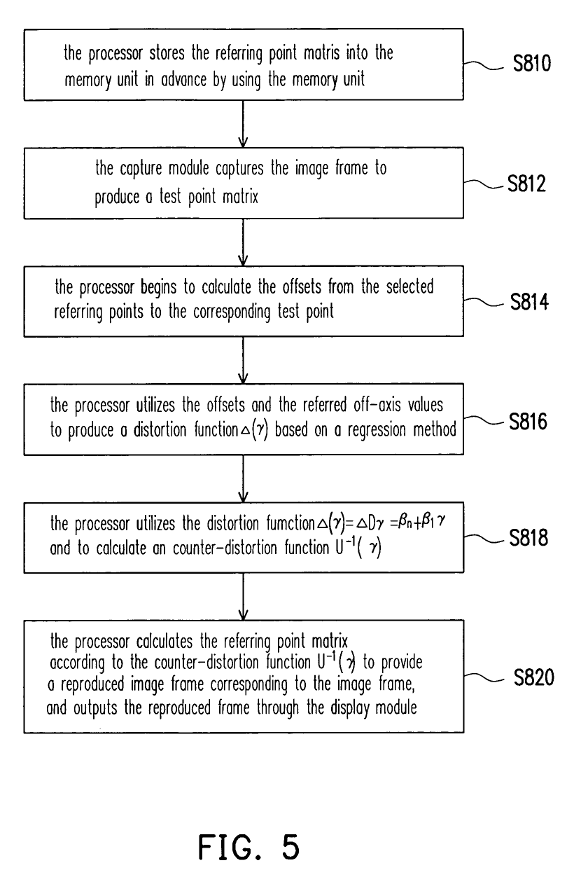

Referring to FIG. 5, the flow chart of the preferred embodiment of the invention, the operating steps include: the processor 54 saving the matrix of reference points 561 into the memory unit 56 in advance by the memory unit 56 (810); the capture module 52 capturing the image frame 60 to generate the matrix of testing points 601 (812); the processor 54 calculating the three offsets of the reference points 561a, 561b, 561c to the corresponding testing points 601a, 601b, 601c (814); the processor 54 using the three calculated offsets 1, 2, 2 and the off-axis values of three reference points: Ra1, Rb1, Rc1 to generate a distortion function. (. ) based on a regression method (816); the processor 54 using the above-described distortion function . (. )=. _{D}.=. ₀+, ₁ . and . to generate a counter-distortion function . . . (. ) (818); and the processor 54 calculating the matrix of reference points 561 according to the counter-distortion function . . . (. ) to provide the reproduced image frame 70 without distortion corresponding to the image frame 60 and outputs the reproduced image frame 70 by the display module 58 (820).

Since the matrix of testing points 601 in the present invention is transferred by the processor 54 after being captured by the capture device 52, different matrices of testing points 601 can generated through different capture devices 52. Additionally, the processor 54 can calculate with different matrices of testing points 601 and matrices of the reference points 561 to generate different counter-distortion functions for subsequently correcting the different distortions generated after the image frame 60 passing through different capture devices 52. In addition, pre-setting counter-distortion function in the electronic device 50 in the process of manufacturing is no longer required since the counter-distortion function utilized by the present invention is dynamically produced via a series of processing after the image frame 60 is captured.

Therefore, the use of the present invention not only improves the distortion generated after an image frame captured by a capture module, but also stimulates the offsets of the reference points in the image frame by utilizing the matrix of reference points being saved and the image fame. Moreover, the present invention can generate different counter-distortion functions dynamically and further correct different distortions of the image frame through different capture devices, without pre-setting an counter-distortion function in the process of manufacturing the electronic device, with convenience.

The above-mentioned is only the preferred embodiments of the present invention and can not be construed as limiting the scope of implement the present invention accordingly, That is to say, all the simply equivalent variations and modifications that is made according to the claims of the present invention and the description still fall within the scope covered by the claims of the present invention.

What is claimed is:

1. A method for reproducing an image frame in an electronic device, the electronic device comprises a capture module, a processor, a memory unit and a display module, the method comprises:
(a) storing a matrix of reference points with a plurality of the reference points into the memory unit wherein the distances between the reference points and the center point of the matrix of the reference points are a plurality of the off-axis values of the reference points;
(b) capturing the image frame through the capture module to generate a matrix of testing points, wherein the testing point matrix comprises a plurality of the testing points;
(c) calculating a plurality of offsets from the testing points to the reference points by the processor;
(d) utilizing the offsets and off-axis values of the reference point to generate a distortion function via the processor based on a regression method;
(e) utilizing the distortion function and the off-axis values of the reference points to generate a counter-distortion function by the processor; and
(f) calculating the matrix of the reference points by the processor according to the counter-distortion function to provide a reproduced image frame without distortion corresponding to the image frame and output the reproduced image frame through the display module.

2. The method for reproducing an image frame according to claim 1, wherein in step (c), any one of the offsets Δ_{D}γ can be derived by the equation _{D}.=. −. , wherein. is any one of the off-axis values of reference points, . is an off-axis value of testing point, the distance between a testing point corresponding to the reference point and the center point of the matrix of the testing points.

3. The method for reproducing an image frame according to claim 2, wherein in step (d), the regression method is a Least-Squares method, and the distortion function Δ(γ) is derived through the regression method, Δ(γ)=Δ_{D}γ=β₀+β₁γ, wherein β₀ and β₁ are regression coefficients.

4. The method for reproducing an image frame according to claim 3, wherein
$${β}_{1} = {\sum }_{i = 1}^{n} ( {γ}_{i} - \overline{γ} ) ( {Δ}_{D} {γ}_{i} - \overline{{Δ}_{D} γ} ) / {\sum }_{i = 1}^{n} {( {γ}_{i} - \overline{γ} )}^{2} , {β}_{0} = \overline{{Δ}_{D} γ} - {β}_{1} \overline{γ} , \\ \overline{γ} = \frac{1}{n} {\sum }_{i = 1}^{n} {γ}_{i} , \overline{{Δ}_{D} γ} = \frac{1}{n} {\sum }_{i = 1}^{n} {Δ}_{D} {γ}_{i} ,$$
wherein n is the number of the testing points.

5. The method for reproducing an image frame according to claim 4, wherein in step (e), the counter-distorting function U⁻¹(γ) is determined by the equation:
U⁻¹(γ)=γ+Δ(γ).
